(19) United States
(12) Patent Application Publication
(10) Pub. No.: US 2011/0298207 A1
(43) Pub. Date: Dec. 8, 2011

(54) MAGNETICALLY ORIENTED INK ON PRIMER LAYER

(75) Inventors: Claude-Alain DESPLAND, Prilly (CH); Mathieu SCHMID, Lausanne (CH); Patrick VEYA, Tolochenaz (CH)

(73) Assignee: SICPA HOLDING SA, Prilly (CH)

(21) Appl. No.: 13/130,683

(22) PCT Filed: Nov. 24, 2009
(86) PCT No.: PCT/EP2009/065731

§ 371 Date: Aug. 2, 2011

(30) Foreign Application Priority Data
Nov. 24, 2008 (IB) PCT/IB2008/003192

(51) Int. Cl. B42D 15/00

(52) U.S. Cl. 283/82

(57) ABSTRACT

Disclosed is a security document (D), having a substrate (S) coated with at least one first coating layer (P), and over said first coating layer (P) at least one second coating layer (I), said second coating layer (I) comprising at least one type of magnetic or magnetizable particles (F), wherein indicia are embodied in the coating layer (I) through a selective orientation of the said magnetic or magnetizable particles (F). Further disclosed is a process of making said security document.

### FIELD OF THE INVENTION

The present invention is in the field of security document printing. It concerns in particular an improvement to an ink-based security element, which is obtained on a fibrous or otherwise porous substrate through printing and magnetically orienting an ink comprising magnetic or magnetizable pigment particles, as well as the production and the use of said security element, and security documents carrying said security element.

### BACKGROUND OF THE INVENTION

Security elements and decorative coatings containing oriented magnetic particles in a printed and cured ink layer, and methods for producing and for using them, are known from U.S. Pat. No. 3,676,273; U.S. Pat. No. 3,791,864; EP 406,667 B1; EP 556,449 B1; EP 710,508 A1; WO 02/90002 A2; WO 2005/002866 A1; WO 2006/061301 A1; WO 2006/117271 A1; WO 2007/131833 A1; as well as from the applications EP 1 880 866 A1 and WO 2008/046702 A1. Particularly useful in this context are optically variable magnetic pigments, such as disclosed in U.S. Pat. No. 4,838,648; in EP 686,675 B1; in WO 02/73250 A2 and in WO 03/00801 A2, WO 2004/024836, and the methods for orienting said pigment in the printed ink, disclosed in EP 1 810 756 A2, WO 2005/002866 A1, WO 2006/069218, in the co-pending application WO 2008/046702 A1, and in the hereto related documents.

According to WO 2005/002866 A1, predetermined indicia, such as lettering, a design, or an image, etc., are magnetically transferred onto a printed document, i.e. a sheet or a web, carrying a layer of a freshly printed, wet ink or coating composition comprising magnetic or magnetizable particles (F), through the exposition of said sheet or web to a plate of permanent-magnetic material which carries said predetermined indicia in the form of engravings in its surface, hereby orienting the magnetic or magnetizing particles (F), followed by curing (hardening) the ink or coating composition so as to immobilize the oriented magnetic or magnetizable particles (F). Patent application WO 2008/046702 A1 is about a further improvement to the magnetic orientation device disclosed in WO 2005/002866 A1.

As disclosed in WO 2007/131833 A1, particular ink formulations are required in order to obtain a visibly appealing result. In particular, in the case of inks containing magnetic platelets, such as optically variable magnetic pigment flakes, the ratio of the volume of the (dried, solvent-free) ink vehicle to the volume of the magnetic pigment should be higher than 3.0, most preferably higher than 5.0, in order to provide enough space in the ink layer for the magnetic pigment particles to freely adopt an externally imposed orientation.

However, it was observed that the quality of the magnetically oriented image depends also to a large extent on the substrate onto which the said layer of ink or coating composition comprising said magnetic or magnetizable particles (F) is applied. Whereas on plastic or metal foils, on polymer substrates, and more generally on very smooth, non porous surfaces, excellent magnetic images are obtainable, the magnetic orientation images obtained on uneven, inhomogeneous fibrous substrates, as well as on porous substrates, are of rather poor quality. Banknote paper falls somewhere in between these extremes of substrates.

On porous or fibrous substrates, the defect most often observed is either an overall reduction of the optical contrast in the magnetic image, or the presence of punctual, small, visible irregularities, characterized by a variation of reflectivity, of color density, or of translucency from one local area to another, which leads to an unpleasant, mottled visual appearance.

WO 2006/061301 A1 discloses a security element having a viewing angle dependent aspect, which can be produced by magnetically orienting platelet-shaped pigment particles in a layer of ink applied over an indicia-carrying background, and subsequently hardening (drying, curing) the ink layer in the oriented state. It was observed that both, the homogeneity and the viewing-angle-dependent optical aspect of the security element, strongly depend on the quality of the substrate onto which the said ink layer is applied. On smooth and non-absorbing substrates, the angle-dependent aspect variation is strong, and large variations of reflectivity and translucency can be observed as a function of the viewing-angle. On fibrous substrates, the angle-dependent aspect variation is poor because the platelet-shaped pigment particles apparently lose their initially imposed magnetic orientation upon drying of the ink.

### SUMMARY OF THE INVENTION

Inventors have now found that the said poor quality of the magnetically oriented image on fibrous or porous substrates can be considerably improved by the application of a first coating layer (primer layer) (P) to the fibrous substrate (S), prior to the application of the coating (I) comprising magnetically orientable pigment.

The details of the invention are disclosed hereafter in the description, the drawings and the claims.

Disclosed is thus a process for obtaining a high-quality magnetically oriented image on a substrate (S), regardless of its nature and surface properties, the process being characterized by the sequential steps of:
a) applying a first coating layer (P) to at least part of the surface of a substrate (S);
c) applying a second coating layer or a second set of coating layers (I) over at least part of the said first coating layer (P); said second coating layer or sec- and set of layers (I) comprising at least one type of magnetic or magnetizable particles (F);
d) exposing the coating layer (I) comprising the magnetic or magnetizable particles (F), while it is wet, to a magnetic field, thereby allowing the said magnetic or magnetizable particles (F) to orient in the said magnetic field;
e) hardening the coating layer (I) comprising the magnetic or magnetizable particles (F), thereby irreversibly fixing the magnetic or magnetizable particles (F) in their respective orientations.

In this process it is of advantage if said applying a first coating layer (P) includes drying or curing the said first coating layer (P) so as to make it touch-resistant.

In the context of the present invention, the first (primer) coating layer can thus also be a first set of (primer) coating layers (P), for purposes such as increasing the layer thickness or exploiting the opacifying properties of the primer coating. In such case, step (a) of the process is repeated.

More than one second coating layer (I) can further be applied onto the primer-coated substrate, e.g. for obtaining more sophisticated optical effects. In such case, step (b), optionally steps (c), and (d), of the process are repeated, to obtain a second set of coating layers.

Disclosed is further a security document or an article (D), obtainable by said process, having a substrate (S) coated with a first coating layer or first set of layers (P), characterized in that it has over at least part of said first coating layer or first set of layers (P) a second coating layer or second set of layers (I), said second coating layer or second set of layers (I) comprising at least one type of magnetic or magnetizable particles (F), and a pattern, an image, or indicia being embodied in the second coating layer or second set of layers (I) through a homogeneous or locally selective orientation of the said magnetic or magnetizable particles (F).

The present invention is particularly advantageous if the substrate (S) is a woven fibrous substrate, a non-woven fibrous substrate, non-fibrous, porous substrate, or a non-porous substrate having a textured or uneven surface structure. The substrate may further carry previously applied coatings, such as paper sizing, anti-soiling treatments, offset-printed backgrounds, and the like.

The security document or the article (D) can be a bank note, a value document, an identity document, a (credit-, access-, identity-, etc.) card, a tax excise stamp, a label, a packaging, or a commercial good.

The primer layer may be applied by a large variety of coating processes, such ink-jet printing, offset printing, flexographic printing, gravure printing, screen printing, letterpress printing, decal printing, pad-stamping, and roller-coating; and it can have a thickness ranging from as low as 0.3 micrometers up to 50 micrometers or more, depending on the chosen technology. The primer may furthermore be applied in a wet-on-wet process, wherein the subsequent layer is applied without previous drying of the primer layer, or, alternatively the primer layer may be dried prior to the application of the subsequent layer.

It has been found advantageous that the primer coating (P) being dried or cured before the application of the magnetically orientable coating layer; more specifically, the primer coating (P) should be touch-resistant at the moment of applying the magnetically orientable coating layer (I). The preferred curing mechanism is through chemical crosslinking, either through UV-curing, through electron-beam curing, or through oxypolymerizative curing. Simple physical drying through solvent evaporation, solvent absorption into the substrate, or film-forming through coalescence of polymer droplets from an aqueous emulsion, is less efficient, because a so dried layer remains open to re-dissolution under the influence of the subsequently applied coating layer (I). Touch-resistant, in the context of the present disclosure, means that the coating layer will not adhere to a human finger pressed on it.

The first (or primer) coating layer is thus preferably a UV-curing coating composition. Applying a UV coating has the advantage of the technical possibility of instant drying through irradiation with UV light. Instant drying of the first coating (P) allows the second coating (I) to be applied on the same printing machine in a single pass. An alternatively applicable rapid-curing process is electron-beam curing, applicable with electron-beam curing and most other radiation-curing coating compositions.

In case the first coating layer is applied in a previous step, for instance during the substrate production, UV-curing or radiation-curing properties of the coating composition are not necessarily required, as instantaneous drying is not mandatory in such case. An oxypolymerization drying primer can thus be useful as well if the primer coating is performed in a separate process. Physical drying, e.g. through solvent evaporation or through coalescence of polymer droplets from an emulsion, is less preferred as the sole drying mechanism; however, it can be very advantageously used in combination with one of the preceding drying processes in so-called hybrid-curing systems.

Inventors believe that the primer layer principally reduces the paper's ability to take up (absorb), in an either homogeneous or inhomogeneous (localized) manner, part of the ink vehicle. Absorption of a part of the ink vehicle noteworthy results in an effective lowering of the ratio of ink vehicle to pigment in the printed ink film; such lowering of ratio is known to degrade the optical appearance of the magnetic image, as disclosed in WO 2007/131833 A1.

The advantageous drying or curing the primer layer is thought to help blocking the pores of the fibrous or porous substrate, thus preventing absorption, by the substrate, of ink vehicle of the subsequently applied second coating (I), and ensuring therewith that a sufficient amount of liquid is available in the second coating during the subsequent magnetic orientation step, so as to allow the magnetically orientable pigment particles to freely rotate within the ink vehicle and to align with the imposed exterior magnetic field.

A further advantage of the primer layer is to render the printing of the optically variable magnetic ink or the ink containing magnetically orientable pigment particles virtually independent of the chemical and physical properties of the substrate surface. This allows the primer coating to be formulated so as to be compatible with both, the substrate and the ink containing magnetically orientable pigment particles. Such compatibility can be achieved much easier for a primer coating formulation than for the ink formulation comprising magnetically orientable pigment, which, due to its special pigment content, is subject to much more stringent formulation requirements.

In a preferred embodiment, said first coating layer or at least the topmost of said first set of layers (P) has the additional property of promoting the adhesion between the substrate (S) and the said magnetically oriented second coating layer or second set of layers (I).

The first coating (primer) layer (P) may be a colorless, transparent coating or a cholesteric liquid crystal polymer (CLCP) coating. In a preferred embodiment, however, the first coating layer, or at least one of said first set of layers, comprises one or more overt elements selected from the group comprising the soluble dyes and the insoluble pigments. In particular, said pigment may be chosen from the white or colored opaque pigments, the metallic pigments, the iridescent pigments, the optically variable pigments, and the cholesteric liquid crystal polymer (CLCP) pigments.

Said first coating layer or at least one of said first set of layers (I) may further comprise one or more covert element, chosen from the group consisting of the ultraviolet-luminescent compounds, the visible-luminescent compounds, the infrared-luminescent compounds, the up-converting compounds, the infrared-absorbing compounds, the magnetic compounds, and the forensic taggants.

An overt element, in the context of the present description, is a material which can be admixed to, or which is otherwise part of a coating composition, and which exhibits at least one visibly distinctive property, such as color, color-shift or iridescence. Overt elements can be visually authenticated.

A covert element, in the context of the present description, is a material which can be admixed to, or which is otherwise part of a coating composition, and which exhibits at least one non-visibly distinctive property, such as luminescence, magnetism or IR-absorption. Covert elements need particular equipment for their authentication.

In a particular embodiment, said first coating layer or at least one of said first set of layers comprises a cholesteric liquid crystal polymer (CLCP) material, exhibiting viewing-angle dependent color and reflecting a circularly polarized light component within a determined wavelength range.

Said first coating layer or at least one of said first set of layers (P) may further carry information, such as a serial number or personalization information, being inscribed by a method of variable-information-printing, preferably by laser marking.

The magnetic or magnetizable particles (F) of the second coating layer or set of second layers (I) are preferably embodied by a magnetic flake pigment, more preferably by optically reflective magnetic pigment flakes.

The magnetic or magnetizable particles (F) of the second coating layer or set of second layers (I) can also be advantageously embodied by an optically variable magnetic pigment, preferably by a thin-film interference pigment comprising either an {absorber layer/dielectric layer/reflecting magnetic layer}, or an {absorber layer/dielectric layer/reflector layer plus a magnetic layer} sequence. In the latter sequence, the magnetic functionality is separated from the reflector functionality, and embodied as an additional layer, which may either be located adjacent to the reflector layer, or separated from the reflector layer by one or more additional layers.

Said second coating layer, or at least one of said second set of layers (I), may further comprise one or more covert elements, chosen from the group consisting of the ultraviolet-luminescent compounds, the visible-luminescent compounds, the infrared-luminescent compounds, the up-converting compounds, the infrared-absorbing compounds, the magnetic compounds, and the forensic taggants.

In a particularly preferred embodiment of the method, said second coating layer (I) comprising said at least one type of magnetic or magnetizable particles (F), is exposed, while it is wet, to the magnetic field of an indicia-engraved, permanent magnetic plate, such as disclosed in WO 2005/002866 A1 or in the co-pending application WO 2008/046702 A1, and hardened during or after said exposition. This allows achieving a line width (r) of the obtained magnetic orientation pattern, image or indicia which is lower than 3 millimeters, preferably lower than 2 millimeters, most preferably lower than 1 millimeter.

Said first coating layer, or at least one of said first set of layers (P), can further be printed as a solid surface being more extended than the second coating layer or second set of layers (I).

Said first coating layer, or at least one of said first set of layers (P), can also be printed in the form of indicia, lines, raster, grid, logo, geometric patterns, in a way that it selectively impacts the magnetic image in the areas of superposition with the second coating layer or second set of layers (I).

### DETAILED DESCRIPTION OF THE INVENTION

The present invention comprises a process for the application of a magnetic orientation image to a substrate (S), having the sequential process steps of applying a first (primer) coating (P) onto the substrate (S), optionally followed by hardening the applied primer coating (P), then applying a second coating (I) comprising magnetic or magnetizable particles (F) over at least part of the primer coating (P), followed by exposing the second coating (I), while wet, to a magnetic field, so as to magnetically orient the particles (F) in the coating layer (I), herewith embodying a pattern, an image, or indicia in the second coating layer (I), followed by hardening the oriented coating layer (I), so as to fix the particles (F) in their oriented positions.

Said pattern, image, or indicia may be everything which can be produced through the orientation, in a homogeneous or in a locally selective way, of anisotropic particles, i.e. needles or flakes, comprised in a coating. In homogeneous orientation, all particles of a determined surface area adopt a same, common direction, such as disclosed in WO 2006/061301 A1, whereas in locally selective orientation, the particles adopt locally varying direction, so as to represent a pattern, an image, a logo, or still other types of indicia.

The invention further comprises a security document or an article (D), obtainable by the process, having a substrate (S) coated with a first coating layer or first set of layers (P), and characterized in that it has over at least part of said first coating layer or first set of layers (P) a second coating layer or second set of layers (I), said second coating layer or second set of layers (I) comprising at least one type of magnetic or magnetizable particles (F), and a pattern, an image, or indicia being embodied in the second coating layer or second set of layers (I) through a homogeneous or locally selective orientation of the said magnetic or magnetizable particles (F).

The substrate of the security document or article (D) is preferably a fibrous substrate, such as a paper or cardboard; more generally, it may be any woven or non-woven fibrous substrate. It may also be a non-fibrous, porous substrate, e.g. a plastic substrate having a porous surface, or even a non-porous substrate having a textured or uneven surface structure. The substrate may be opaque, transparent or translucent. It can further be colorless or colored. The substrate may be uncoated, or pre-coated with sizing agents, anti-soiling treatments, etc., it may further be blank or carry printings, such as an offset background.

The process according to the present invention is advantageously used for the production of security documents or articles (D), such as bank notes, value documents, identity documents, cards, tax excise stamps, labels, packaging etc., as well as for the marking of commercial goods against counterfeiting and diversion (product security applications).

The first, or primer coating layer, which can also be a first set of layers (P), has a thickness in the range of between 0.3 and 50 micrometers. The crucial layer considered in the context of the present invention is the topmost of said set of layers (P) in case the document carries a multiple coating, comprising e.g. paper treatments, background printings, and the like.

The said first coating layer (P) may be applied by any printing process known in the art, in particular a process chosen from the group consisting of ink-jet printing, offset printing, flexographic printing, gravure printing, screen printing, letterpress printing, decal printing, pad-stamping, and roller-coating; however it is most preferably applied by one of the flexographic, gravure or screen-printing processes. Said first coating layer (P) is preferably printed as a solid surface being more extended than the second coating layer (I), or printed as lines, raster, grid, logo, geometric patterns, in a way that it selectively impacts the magnetic image in the areas of superposition with the second coating layer (I).

The coating layer (P) is most preferably a radiation-curable coating, such as a UV or electron beam coating composition, e.g. a UV-drying screen printing ink, or a UV drying ink-jet, offset, flexography, gravure ink or roller coating ink. Radiation curing noteworthy results in a rapid (instant) drying, and therefore allows for high production speeds on the printing press. When the coating layer is applied in a previous step of the production, and when therefore an instantaneous drying is not mandatory, it can be also a solvent-based or a water-based coating, drying by evaporation or penetration of its constitutive solvents, or by any other drying process, such as oxypolymerisation or chemical crosslinking.

Although wet-on-wet processes are possible, wherein the second coating is applied onto the primer coating without previous drying the latter, said primer (P) is preferably dried or cured prior to the application of the magnetically orientable coating (I). Such drying or curing is helpful to obtain the best effect out of the present invention. The primer coating layer should be cured at least to the point where it is touch-resistant, i.e. where it does no longer show any set-off and can touch the printing equipment, for the application of the second layer, without being damaged or soiling the printing equipment. Said drying may be achieved, according to the chemical nature of the primer coating, through UV-radiation, electron-beam radiation, heating, or still other drying or curing mechanisms which lead to a hardening of the coating.

Primer coatings (P) based on other chemistries, such as water-based emulsion coating compositions, solvent-based thermoplastic or thermosetting coating compositions, air-drying coating compositions, hybrid compositions including waterbased/UV curing and solvent-based/UV curing components may be used as well.

The primer coating is thus chosen from the group consisting of the UV-curing coatings, the solvent-based coatings, the water-based coatings including but not limited to the emulsion coatings, the oxidatively drying coatings, the waterbased/UV drying hybrid coatings and the solvent-based/UV drying hybrid coatings

In a particular embodiment, said first coating layer or at least one of said first set of layers comprises a cholesteric liquid crystal polymer (CLCP) material, exhibiting viewing-angle dependent color and reflecting a circularly polarized light component within a determined wavelength range. Such materials, disclosed e.g. in U.S. Pat. No. 5,798,147 (Beck et al.) and U.S. Pat. No. 6,899,824 (Meyer et al.), can be applied in the form of a precursor liquid crystal coating, which, when subject to determined external conditions (temperature), develops a characteristically colored cholesteric texture. The cholesteric texture is then “frozen” through the photopolymerization of the precursor material.

In another embodiment, the topmost primer layer (P) is a colorless, transparent coating. In another preferred embodiment, the primer coating comprises a soluble dye and/or an insoluble pigment. A colored dye or pigment can be chosen so as to reinforce the optical effect of the optically variable magnetic ink and the magnetic image overprinted on top of the primer. Preferably said pigment is chosen from the white or colored opaque pigments, the metallic pigments, the iridescent pigments, the optically variable pigments, and the mixtures thereof.

An optical effect pigment, such as a color shifting, an iridescent, or a metallic pigment, can provide additional security to the document whilst enriching the overall aspect of the magnetic image.

In a particularly preferred embodiment, said primer (P) comprises one or more transparent or colored cholesteric liquid crystal polymer (CLCP) pigments, exhibiting viewing-angle dependent color and reflecting circularly polarized light of a determined sense within a determined wavelength range.

Cholesteric liquid crystal polymers have a molecular order in the form of helically arranged molecular stacks. This order is at the origin of a periodic spatial modulation of the material's refractive index, which in turn results in a selective transmission/reflection of determined wavelengths and polarization senses of light. The particular situation of the helical molecular arrangement in CLCPs causes the reflected light to be circular polarized, left-handed or right-handed, depending on the sense of rotation of the molecular helical stack. The presence of circular polarization as an additional hidden feature is a further security element.

The preferred CLCP pigments are flakes of the type described in EP 1 876 216 A1, EP 1 213 338 B1; EP 0 685 749 B1; DE 199 22 158 A1; EP 0 601 483 A1; DE 44 18 490 A1; EP 0 887 398 B1, and WO 2006/063926, as well as in U.S. Pat. No. 5,211,877, U.S. Pat. No. 5,362,315 and U.S. Pat. No. 6,423,246. The pigment particles have a thickness of the order of 1 to 10 micrometers and a flake size of the order of 10 to 100 micrometers, and are obtained by comminution of a corresponding liquid-crystalpolymer precursor film.

The primer coating (P) may further comprise covert security elements, chosen from the group consisting of the ultraviolet-luminescent compounds, the visible-luminescent compounds, the infrared-luminescent compounds, the up-converting compounds, the infrared-absorbing compounds, the magnetic pigments, and the forensic taggants.

Luminescent dyes or pigments, as well as infrared-absorbing compound can provide the document with additional covert and machine-readable security markings, providing for machine-authenticate-ability of the security document according to established technology. A magnetic pigment in the primer layer can additionally provide for cooperative effects with the oriented optically variable magnetic pigment in the second layer. A forensic security marker, such as disclosed in EP 0 927 750 B1, can provide for trace-ability of an ink marked therewith, and of the correspondingly printed documents.

Said first coating layer (P) may further carry information, such as a serial number or personalization information, which may be applied by a method of variable-information-printing, such as laser marking.

Said primer (P) may have the additional property or function to promote the adhesion between the substrate (S) and the magnetically oriented coating layer (I).

Such may be noteworthy required in the case of surface-treated paper, having e.g. an anti-soiling coating, such as is frequently used for banlmote printing. Anti-soiling coated papers are difficult to imprint with standard ink formulations. On the other hand, changing a functional ink formula, such as an optically variable magnetic ink, so as to additionally exhibit improved adhesion properties is a difficult task. Providing a primer coating composition having adhesion-promoting functionality is much easier to achieve and is thus a preferred choice in case of adhesion problems.

Said magnetic or magnetizable particles (F) in said second coating layer or second set of layers (I) are preferably embodied by magnetic pigment flakes, such as iron flakes, most preferably either by optically reflective magnetic pigment flakes, as disclosed in U.S. Pat. No. 6,818,299 (Phillips et al.), or by optically variable magnetic pigment, such as disclosed in U.S. Pat. No. 4,838,648; in EP 686,675 B1; in WO 02/73250 A2 and in WO 03/00801 A2.

An exemplary embodiment of optically reflective magnetic pigment flakes is a thin-film pigment comprising a reflector layer/magnetic layer/reflector thin-layer sequence, e.g. realized in MgF₂/Al/Ni/AVMgF₂, wherein the reflector layers are embodied by aluminum, and the magnetic layer is embodied by nickel.

The magnetic or magnetizable particles (F) in said second coating layer or second set of layers (I) are most preferably embodied by optically variable magnetic pigment.

An exemplary embodiment of optically variable magnetic pigment is a thin-film interference pigment comprising either an absorber layer/dielectric layer/reflecting magnetic layer, or an absorber layer/dielectric layer/reflector layer plus magnetic layer sequence. Such pigment is based on a Fabry-Perot resonator struchire, wherein the wavelengths of reflected light are determined by the optical thickness of the dielectric layer. Pigments having separate magnetic and optical reflector layers are advantageously used, because they allow to freely combine magnetic and optical reflecting properties, as is disclosed in EP 1 266 380 B1.

The orientation of the pigment particles (F) in the wet printed ink or coating composition (I) is imposed by the external applied magnetic field. A minimum thickness of the ink film layer (I) on the substrate is required to allow for rotational freedom of the magnetic pigment particles (e.g. flakes, F) in the ink medium, such that the pigment particles (F) can freely align with the applied magnetic field. The second coating is therefore applied in a typical film thickness of 10 to 30 mlcrometers.

The process of the present invention is particularly advantageous in the case of the magnetic orientation transfer of a fine line pattern or of high-resolution indicia, such as disclosed in WO 2005/002866 A1 and in the co-pending application WO 2008/046702 A1. It has been found that an excellent quality of the magnetically transferred image is required if this latter contains fine line details, and that, in order to correctly transfer fine line details onto a fibrous substrate such as banknote paper, a primer coating according to the disclosure of the present invention is essential and strongly improves the optical appearance of the magnetically oriented security element.

A fine line detail in the context of the present invention is to be understood as having a line width (r) lower than 3 millimeters. Using the devices disclosed in WO 2005/002866 A1 and in WO 2008/046702 A1, line widths lower than 2 millimeters, and even lower than 1 millimeter can be easily transferred as a magnetic orientation pattern. FIG. 2 illustrates the line width (r) of a pattern obtained by magnetic transfer into the second coating (I), and how it is linked to the nature of the magnetic field lines of the magnetic orientation plate (M).

In a particular embodiment, the surface coated with the said primer (P) may extend beyond the area of the second coating layer (I) printed with the optically variable magnetic ink or the ink containing magnetically oriented pigment particles, i.e. the entire surface of the magnetically oriented ink may be contained within the primer surface. The primer area may also, in an alternative embodiment, be primted less extended than the second coating layer (I).

In another particular embodiment, said first coating layer (P) is printed as lines, raster, grid, logo, geometric patterns, in a way that it selectively impacts the magnetic image in the areas of superposition with the second coating layer (I). Particularly preferred is further a document or article (D) comprising a fine-line magnetic image, i.e. wherein the said indicia have a line width (r) lower than 3 mm, preferably lower than 2 mm, most preferably lower than 1 mm; such indicia can be produced using the orientation devices disclosed in WO 2005/002866 A1 or in WO 2008/046702 A1.

The invention is now further explained with respect to the drawings and exemplary embodiments

### BRIEF DESCRIPTION OF THE DRAWINGS

FIG. 1 schematically illustrates the security element of the present invention: S is the fibrous or porous substrate; P is the first coating (primer coating), I is the second coating comprising at least one type of magnetic or magnetizable particles (F), wherein indicia are embodied through a selective orientation of the said magnetic or magnetizable particles (F).

FIG. 2 illustrates the dependency of the line width (r) of a pattern, obtained by magnetic orientation of particles in a coating (I), of the magnetic field used to orient the particles. Fine-line patterns require abrupt reversals of the magnetic field.

FIG. 3 illustrates the effect of the applied primer layer (P) on the formation of magnetic orientation images on a “difficult” substrate (absorbing offset paper):

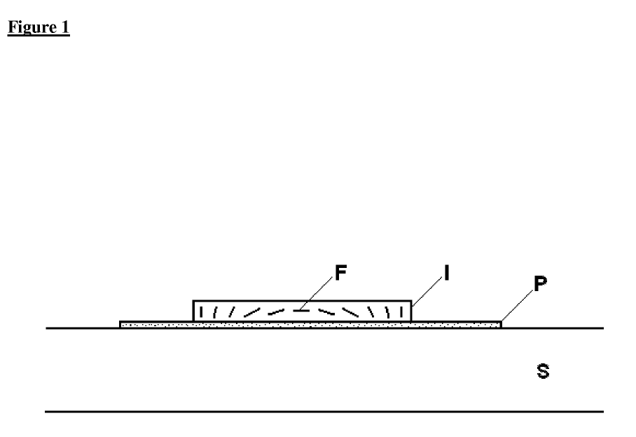

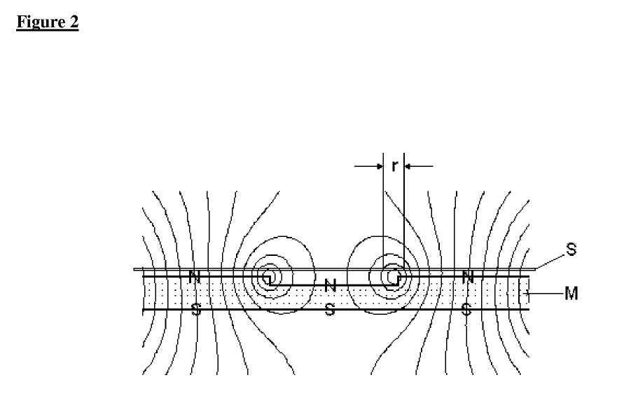

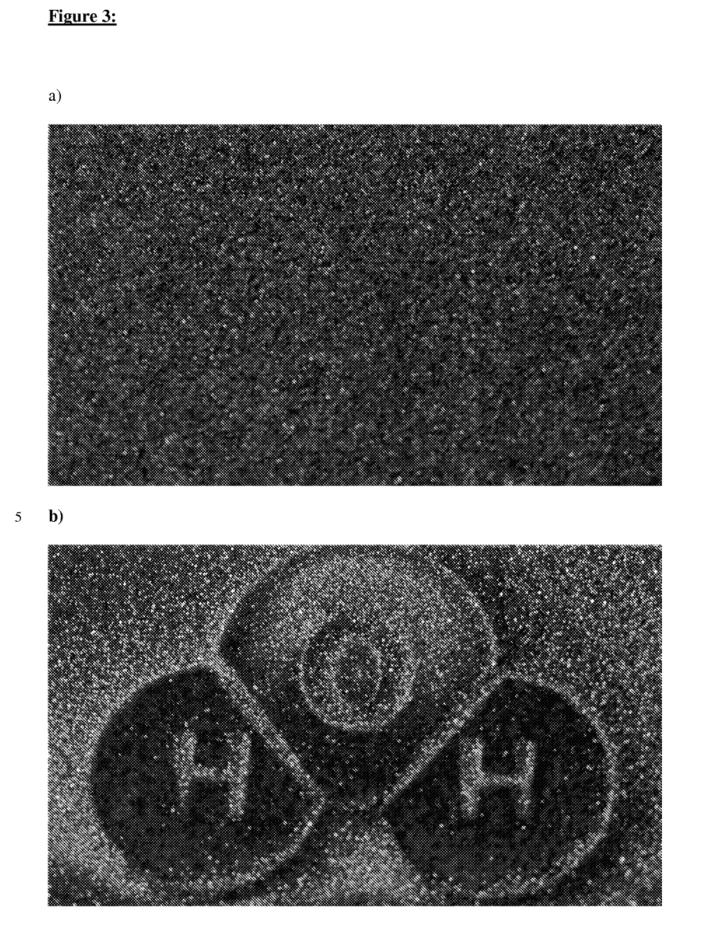

a) optically variable magnetic ink (I) directly printed onto the substrate (S), followed by magnetic orientation of the pigment and hardening of the ink: no image is visible;

b) optically variable magnetic ink (I) printed onto a primer layer (P) of the present invention, otherwise same conditions as in (a): The magnetic orientation image appears clear and neat.

c) optically variable magnetic ink (I) printed half on a primer layer (P), half on the substrate (S), otherwise same conditions as in (a): The magnetic orientation image appears clear and neat in the primer-coated part (left), but not at all in the uncoated part (right).

### EXAMPLES

### Ink Formulas

Inks for the first (primer) coating (P) are made as known to the skilled person. A first example of a UV-curing primer formula for the application by the flexography process is as follows:

| | |
|---|---|
| Epoxyacrylate oligomer | 49% |
| Trimethylolpropane triacrylate monomer | 20% |
| TMPTA | |
| Tripropyleneglycol diacrylate monomer | 20% |
| TPGDA | |
| Genorad 16 (Rahn) | 1% |
| Aerosil 200 (Degussa-Huels) | 2% |
| lrgacure 500 (Ciba) | 6% |
| Genocure EPD (Rahn) | 2% |

A second, alternative UV-drying primer comprising a luminescent marker for the application by silkscreen printing is formulated as follows:

| | |
|---|---|
| Epoxyacrylate oligomer | 47% |
| Trimethylolpropane triacrylate monomer | 20% |
| TMPTA | |
| Tripropyleneglycol diacrylate monomer | 20% |
| TPGDA | |
| Luminnescent pigment (Cartax CXDP, | 3% |
| supplied by Clariant) | |
| Genorad 16 (Rahn) | 1% |
| Aerosil 200 (Degussa-Huels) | 1% |
| Irgacure 500 (Ciba) | 6% |
| Genocure EPD (Rahn) | 2% |

A third example consists in a 2 layers primer. The substrate is first printed with an oxidative drying process magenta sheet-fed offset ink. Once this first layer is dried, a UV-drying screen-printing primer, comprising a LCP flake pigment, is applied on the offset layer. The formulation of the silkscreen primer is the following:

| | |
|---|---|
| Epoxyacrylate oligomer | 43% |
| Trimethylolpropane triacrylate monomer | 18% |
| TMPTA | |
| Tripropyleneglycol diacrylate monomer | 18% |
| TPGDA | |
| Helicone HC Maple S (LCP Technologies) | 10% |
| Genorad 16 (Rahn) | 1% |
| Aerosil 200 (Degussa-Huels) | 2% |
| Irgacure 500 (Ciba) | 6% |
| Genocure EPD (Rahn) | 2% |

The second coating composition (I), comprising magnetic optically variable pigment, is formulated as disclosed in WO 2007/131833 A1. An example of a UV-drying silk-screen ink formula is as follows:

| | |
|---|---|
| Epoxyacrylate oligomer | 40% |
| Trimethylolpropane triacrylate monomer | 10% |
| TMPTA | |
| Tripropyleneglycol diacrylate monomer | 10% |
| TPGDA | |
| Genorad 16 (Rahn) | 1% |
| Aerosil 200 (Degussa-Huels) | 1% |
| Irgacure 500 (CIBA) | 6% |
| Genocure EPD (Rahn) | 2% |
| Magnetic optically variable pigment (5 layers)* | 20% |
| Dowanol PMA | 10% |

Viscosity (mPa · s, Brookfield) 800
*supplied by FLEX Products, Inc., Santa Rosa, CA

### Printing and Magnetic Orientation

A first sheet of standard offset paper was used as such. A second sheet of standard offset paper was silk-screen imprinted as a solid surface with 24 micrometers of the first primer composition given here above, and the printed composition was UV-cured.

Both papers were silk-screen imprinted with a solid patch of the second coating composition (I) given here above, in a thickness of 30 micrometers. The imprinted substrates were briefly placed on an indicia-carrying magnetic plate such as disclosed in WO 2008/046702 A1 and in WO 2005/002866 A1, and the oriented coatings were UV-cured.

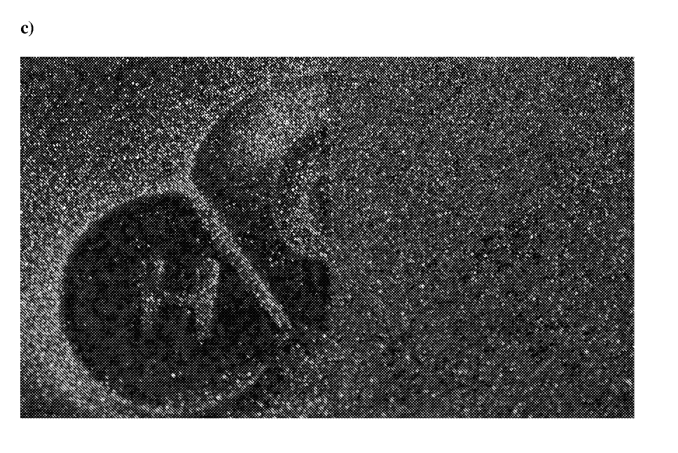

FIG. 3 shows the results obtained under otherwise same conditions: On the paper which was not primer-coated, the magnetic orientation image is not visible (FIG. 3a); whereas on the primer-coated paper, the magnetic orientation image is clear and neat (FIG. 3b). If the indicia-carrying magnetic plate is made to overlap coated and non-coated areas of the second substrate during the image-forming step, then the image is formed only clear and neat where the primer (P) coating is present (FIG. 3c).

1. A security document or an article (D), having a substrate (S) coated with a first coating layer or first set of layers (P), characterized in that it has over at least part of said first coating layer or first set of layers (P) a second coating layer or second set of layers (I), said second coating layer or second set of layers (I) comprising at least one type of magnetic or magnetizable particles (F), and a pattern, an image, or indicia being embodied in the second coating layer or second set of layers (I) through a homogeneous or locally selective orientation of the said magnetic or magnetizable particles (F).

2. A security document or an article (D) according to claim 1, wherein said substrate is chosen from the group consisting of the woven fibrous substrates, the non-woven fibrous substrates, the non-fibrous, porous substrates, and the non-porous substrates having a textured or uneven surface structure.

3. A security document or an article (D) according to claim 1, wherein said first coating layer or first set of layers (P) has a thickness in the range between 0.3 and 50 micrometers.

4. A security document or an article (D) according to claim 1, wherein said first coating layer or at least the topmost of said first set of layers (P) is applied by a process chosen from the group consisting of ink jet printing, offset printing, flexographic printing, gravure printing, screen printing, letterpress printing, decal printing, pad-stamping, and roller-coating.

5. A security document or an article (D) according to claim 1, wherein said first coating layer or at least the topmost of said first set of layers (P) is chosen from the group consisting of the UV-curing coating compositions, the electron-beam-curing coating compositions, the solvent-based coating compositions, the water-based coating compositions, the oxypolymerization drying coating compositions, and the hybrid-curing coating compositions including the water-based/UV curing and the solvent-based/UV curing coatings.

6. A security document or an article (D) according to claim 1, wherein said first coating layer or at least the topmost of said first set of layers (P) is a colorless transparent coating.

7. A security document or an article (D) according to claim 1, wherein said first coating layer or at least one of said first set of layers comprises a cholesteric liquid crystal polymer (CLCP) material, exhibiting viewing-angle dependent color and reflecting a circularly polarized light component within a determined wavelength range.

8. A security document or an article (D) according to claim 1, wherein said first coating layer or at least one of said first set of layers (P) comprises one or more overt elements selected from the group comprising the soluble dyes and the insoluble pigments.

9. A security document or an article (D) according to claim 8, wherein the said pigment is chosen from the group consisting of the white or colored opaque pigments, the metallic pigments, the iridescent pigments, the optically variable pigments, and the cholesteric liquid crystal polymer (CLCP) pigments.

10. A security document or an article (D) according to claim 1, wherein said first coating layer or at least one of said first set of layers (P) comprises one or more covert elements, chosen from the group consisting of the ultraviolet-luminescent compounds, the visible-luminescent compounds, the infrared-luminescent compounds, the up-converting luminescent compounds, the infrared-absorbing compounds, the magnetic compounds, and the forensic taggants.

11. A security document or an article (D) according to claim 1, wherein said first coating layer or at least one of said first set of layers (P) carries information, such as a serial number or personalization information, being inscribed by a method of variable-information-printing, preferably by laser marking.

12. A security document or an article (D) according to claim 1, wherein said first coating layer or at least the topmost of said first set of layers (P) has the additional property of promoting the adhesion between the substrate (S) and the said magnetically oriented second coating layer or second set of layers (I).

13. A security document or an article (D), according to claim 1, wherein said magnetic or magnetizable particles (F) in said second coating layer or second set of layers (I) are embodied by magnetic pigment flakes, preferably by optically reflective magnetic pigment flakes.

14. A security document or an article (D), according to claim 1, wherein said magnetic or magnetizable particles (F) in said second coating layer or second set of layers (I) are embodied by optically variable magnetic pigment, preferably by thin-film interference pigment comprising either an absorber layer/dielectric layer/reflecting magnetic layer, or an absorber layer/dielectric layer/reflector layer plus a magnetic layer sequence.

15. A security document or an article (D), according to claim 1, wherein said second coating layer or at least one of said second set of layers (I) comprises one or more covert elements, chosen from the group consisting of the ultraviolet-luminescent compounds, the visible-luminescent compounds, the infrared-luminescent compounds, the up-converting compounds, the infrared-absorbing compounds, the magnetic compounds, and the forensic taggants.

16. A security document or an article (D) according to claim 1, wherein the line width (r) of the said magnetic orientation pattern, image or indicia is lower than 3 millimeters, preferably lower than 2 millimeters, most preferably lower than 1 millimeter.

17. A security document or an article (D) according to claim 1, wherein said first coating layer or at least one of said first set of layers (P) is printed as a solid surface being more extended than the second coating layer or second set of layers (I).

18. A security document or an article (D) according to claim 1, wherein said first coating layer or at least one of said first set of layers (P) is printed as indicia, lines, raster, grid, logo, geometric patterns, in a way that it selectively impacts the magnetic image in the areas of superposition with the second coating layer or second set of layers (I).

19. A security document or an article (D) according to claim 1, wherein the security document or article is one of the group consisting of the bank notes, the value documents, the identity documents, the cards, the tax excise stamps, the labels, the packaging, and the commercial goods.

20. A process for producing a security document or an article as described in claim 1, said process comprising the steps of
a) applying a first coating layer (P) to at least part of the surface of a substrate (S);
b) applying a second coating layer or second set of layers (I) over at least part of the said first coating layer (P); said second coating layer or second set of layers (I) comprising at least one type of magnetic or magnetizable particles (F);
c) exposing the coating layer (I) comprising the magnetic or magnetizable particles (F), while it is wet, to a magnetic field, thereby allowing the said magnetic or magnetizable particles (F) to orient in the said magnetic field;
d) hardening the coating layer (I) comprising the magnetic or magnetizable particles (F), thereby irreversibly fixing the magnetic or magnetizable particles (F) in their respective orientations.

21. A process according to claim 20, wherein said applying a first coating layer (P) includes drying or curing the said first coating layer (P) so as to make it touch-resistant.

22. A process according to claim 21, wherein said drying or curing is chosen from the group of processes consisting of UV-curing, electron-beam curing, oxypolymerization drying, physical drying, and the combinations thereof.

23. A process according to claim 20, wherein said first coating layer or at least the topmost of said first set of layers (P) is applied by a printing process chosen from the group consisting of ink jet printing, offset printing, flexographic printing, gravure printing, screen printing, letterpress printing, decal printing, pad-stamping, and roller-coating.

24. A process according to claim 20, wherein information, such as a serial number or personalization information, is inscribed in said first coating layer or at least one of said first set of layers (P) by a method of variable-information-printing, preferably by laser marking.

25. A process according to claim 20, wherein said magnetic or magnetizable particles (F) in said second coating layer or second set of layers (I) are embodied by magnetic pigment flakes, preferably by optically reflective magnetic pigment flakes.

26. A process according to claim 20, wherein said magnetic or magnetizable particles (F) in said second coating layer or second set of layers (I) are embodied by optically variable magnetic pigment, preferably by thin-film interference pigment comprising either an absorber layer/dielectric layer/reflecting magnetic layer, or an absorber layer/dielectric layer/reflector layer plus a magnetic layer sequence.

27. A process according to claim 20, wherein said second coating layer or second set of layers (P) is applied over a coating comprising a cholesteric liquid crystal polymer (CLCP) material.

28. A process according to claim 20, wherein said second coating layer or second set of layers (I) comprising said at least one type of magnetic or magnetizable particles (F), is exposed while it is wet to the magnetic field of an indicia-engraved, permanent magnetic plate.
